(19) United States
(12) Patent Application Publication
(10) Pub. No.: US 2011/0205145 A1
(43) Pub. Date: Aug. 25, 2011

(54) Optoelectronic Device, Display and Backlight Module

(75) Inventors: Po-Iem Lin, Hsin-Chu (TW); Meng-Jia Hsiao, Hsin-Chu (TW); Su-Yi Lin, Hsin-Chu (TW)

(73) Assignee: AU OPTRONICS CORPORATION, Hsin-Chu (TW)

(21) Appl. No.: 12/785,968

(22) Filed: May 24, 2010

(30) Foreign Application Priority Data
Feb. 24, 2010 (TW) 99105337

(51) Int. Cl. G09G 3/36; F21V 7/22

(52) U.S. Cl. 345/102; 362/613; 362/612

(57) ABSTRACT

A backlight module comprises a light transmission member and a light emitting module. The light emitting module includes at least two circuit substrates and a plurality of light emitting units. Short sides of the circuit substrates are corresponding to each other. The light emitting units are disposed on the circuit substrates and face a light incident surface of the light transmission member. The illumination chromaticity of several light emitting units disposed on the circuit substrates and adjacent to each other, and the mixed illumination chromaticity of other light emitting units disposed on each circuit substrate are substantially the same, and all emits white light.

### RELATED APPLICATIONS

This application claims priority to Taiwan Application Serial Number 99105337, filed Feb. 24, 2010, which is herein incorporated by reference.

### BACKGROUND

1. Technical Field

The present invention relates to a backlight module, especially to a backlight module of a display.

2. Description of Related Art

The location of light source in backlight module is generally designed as “side type” or “direct type” in which the side type design is to install the light source device at a lateral side of a light guide panel, wherein the lateral side as a light incident surface, then the light path is controlled by the light guide panel for providing an unifying light source to a liquid display panel. The light source of backlight module often uses light emitting diode light bar (LED-light bar) which is an elongated circuit board disposed with a plurality of light emitting diodes with a matrix arrangement.

Because the sensitivity of human's eyes to wavelength and brightness of colors, when the light emitting diodes are viewed as a matrix, the unselected light emitting diodes may cause a non-unified illumination therefore the viewing effect for users are lowered. So each massive production of light emitting diodes is processed with operations of screening chromaticity and color for determining the chromaticity coordinates (or namely chromaticity bin) and chromaticity for each light emitting diode.

In the past, only those light emitting diodes defined within the white light chromaticity coordinates can be used as a light source for backlight module, so light emitting diodes defined at other chromaticity coordinates can not be adopted as the light source for backlight module, and have to be used for other purposes instead or throw away. Then, for lowering the production cost of light emitting diodes so as to lower the manufacturing cost of backlight module, makers would select the light emitting diodes whose illumination chromaticity at the chromaticity coordinates can be complemented and mixedly arranged on the same LED-light bar for obtaining an anticipated illumination chromaticity.

The trend for flat display is aimed at larger and thinner sizes. When fabricating a flat display with small volume and larger size, a large backlight module capable of providing a large plane light source is needed. So several LED-light bars are arranged at a light incident surface of a lateral side of a light guide panel by connecting the short sides of the light bars, so that the light emitting diode matrix can emit lights towards the light incident surface of the light guide panel.

However, since the version number of LED-light bar is yet unified, the mixed illumination chromaticity of closest-disposed light emitting diodes in every two adjacent LED-light bars at the lateral side of light guide panel will be yellow-white (or namely yellowish) or blue-white (or namely bluish), thus, a non-unified light source will be presented to the light guide panel, therefore the light emitting quality of backlight module and image quality of flat display are degraded.

So how to develop a backlight module capable of solving the mentioned disadvantages shall be seriously concerned.

### SUMMARY

The present invention is to provide an optoelectronic device, a display, and a backlight module for effectively improving light uniformity of lighting member.

One solution provided by the present invention is to provide a backlight module, comprises a light transmission member and a light emitting module. At least one side of the light transmission member is as a light incident surface. The light emitting module is disposed on the light incident surface of the light transmission member and at least includes a first circuit substrate, a second circuit substrate and a plurality of light emitting units. The first circuit substrate and the second circuit substrate respectively have a short side, the short side of the first circuit substrate is corresponding to the short side of the second circuit substrate. The light emitting units are respectively disposed on the first circuit substrate and the second circuit substrate. Also, among the light emitting units, (1) the illumination chromaticity of several light emitting units which are adjacent to each other and disposed on the first circuit substrate and the second circuit substrate, (2) the mixed illumination chromaticity of other light emitting units which are disposed on the first circuit substrate, and (3) the mixed illumination chromaticity of other light emitting units which are disposed on the second circuit substrate are substantially the same.

Another solution provided by the present invention is to provide a display disposed with the mentioned backlight module.

One another solution provided by the present invention is to provide an optoelectronic device disposed with the mentioned display.

Therefore, the display of the optoelectronic device provided by the present invention is able to provide unified illumination chromaticity of light-outputting quality and great image quality of flat display.

### BRIEF DESCRIPTION OF THE DRAWINGS

FIG. 1 is a light emitting diode chromaticity diagram.

FIG. 2 is a schematic view of the display of one embodiment of the present invention.

FIG. 3A is a schematic view of the backlight module of one embodiment of the present invention.

FIG. 3B is a schematic view of one embodiment illustrating the arrangement of the light emitting units shown in FIG. 3A.

FIG. 3C is a schematic view of another embodiment illustrating the arrangement of the light emitting units shown in FIG. 3A.

FIG. 3D is a schematic view of one another embodiment illustrating another arrangement of the light emitting units shown in FIG. 3A.

FIG. 3E is a schematic view of one another embodiment illustrating another arrangement of the light emitting units shown in FIG. 3A.

FIG. 4 is a schematic view of the backlight module of another embodiment of the present invention.

FIG. 5 is a schematic view of the backlight module of one another embodiment of the present invention.

FIG. 6 is a schematic view of the backlight module of one another embodiment of the present invention.

FIG. 7 is a schematic view of the backlight module of one another embodiment of the present invention.

FIG. 8 is a schematic view of the optoelectronic device of one another embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

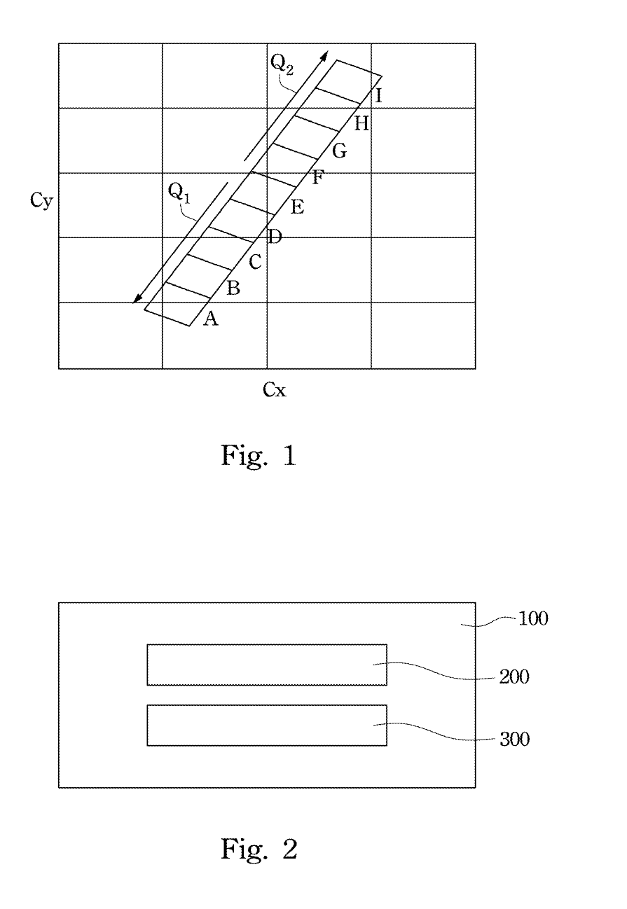

Referring to FIG. 1, which is a light emitting diode chromaticity diagram. After defining the chromaticity of a massive production light emitting diodes, multi chromaticity coordinates (or namely chromaticity bin) are determined (e.g. A-I chromaticity coordinates). Generally, the chromaticity coordinates of a middle area (e.g. E chromaticity coordinate, wherein the Cx is about 0.3 to about 0.4 and Cy is about 0.3 to about 0.4) thereof is an average chromaticity arrange, the color of the average chromaticity arrange substantially emits white light.

From the middle chromaticity coordinates (e.g. the E chromaticity coordinate) towards other chromaticity coordinates according to a Q1 direction (e.g. from E chromaticity coordinate to A chromaticity coordinate), the light illuminated within the chromaticity coordinate ranges is defined as cold color, that is, the color of illumination chromaticity changes from white light (e.g. the E chromaticity coordinate) gradually to bluish-white (cold) light (e.g. the D chromaticity coordinate), light blue (cold) light (e.g. the chromaticity coordinates of C and B), eventually to blue (cold) light (e.g. the A chromaticity coordinate, wherein the Cx is about 0.1 to about 0.2 and Cy is about 0.05 to about 0.1).

On the other hand, from the middle chromaticity coordinates (e.g. the E chromaticity coordinate) towards another chromaticity coordinates according to a Q2 direction (e.g. from E chromaticity coordinate to I chromaticity coordinate), the light illuminated within the chromaticity coordinates is defined as warm color, that is, the color of illumination chromaticity changes from white light (e.g. the E chromaticity coordinate), gradually to reddish-white (warm) light (e.g. the F chromaticity coordinate), light red (warm) light (e.g. the chromaticity coordinates of G and H), eventually to red (warm) color (e.g. the I chromaticity coordinate, wherein the Cx is about 0.55 to about 0.65 and Cy is about 0.3 to about 0.4).

Moreover, the chromaticity coordinates defined as moving from the middle chromaticity coordinate along the Q1 direction, and the chromaticity coordinates defined as moving from the middle chromaticity coordinate along the Q2 direction are general determinations. If further defining the application of display panel, the chromaticity coordinates mentioned above may alter.

For example: when the display panel is in a large size (e.g. a TV display panel), the middle chromaticity coordinates (e.g. the E chromaticity coordinate, wherein the Cx is about 0.25 to about 0.27 and Cy is about 0.22 to about 0.24); when the display panel is in a middle/small size (e.g. a display panel for notebook computer or a mobile phone), the middle chromaticity coordinates (e.g. the E chromaticity coordinate, wherein the Cx is about 0.28 to about 0.31 and Cy is about 0.28 to about 0.30). Therefore, with respect to different sizes and applications of display panel, chromaticity coordinates defined as respectively moving toward the Q1 and Q2 directions will be altered, for example: the chromaticity coordinates defined as moving along the Q1 direction (e.g. the A chromaticity coordinate, wherein the Cx is about 0.22 to about 0.24 and Cy is about 0.19 about to 0.21); the chromaticity coordinate defined as moving along the Q2 direction (e.g. the I chromaticity coordinate, wherein the Cx is about 0.27 to about 0.29 and Cy is about 0.26 to about 0.28).

As such, if the middle chromaticity coordinate (e.g. the E chromaticity coordinate) is set as a middle point, the illumination chromaticity of the chromaticity coordinates (e.g. the A chromaticity coordinate and the I chromaticity coordinate) symmetrically defined from two lateral sides of the chromaticity coordinate of the middle point (e.g. the E chromaticity coordinate) can be mixed to form the white light similar to the chromaticity coordinate of the middle point (e.g. the E chromaticity coordinate).

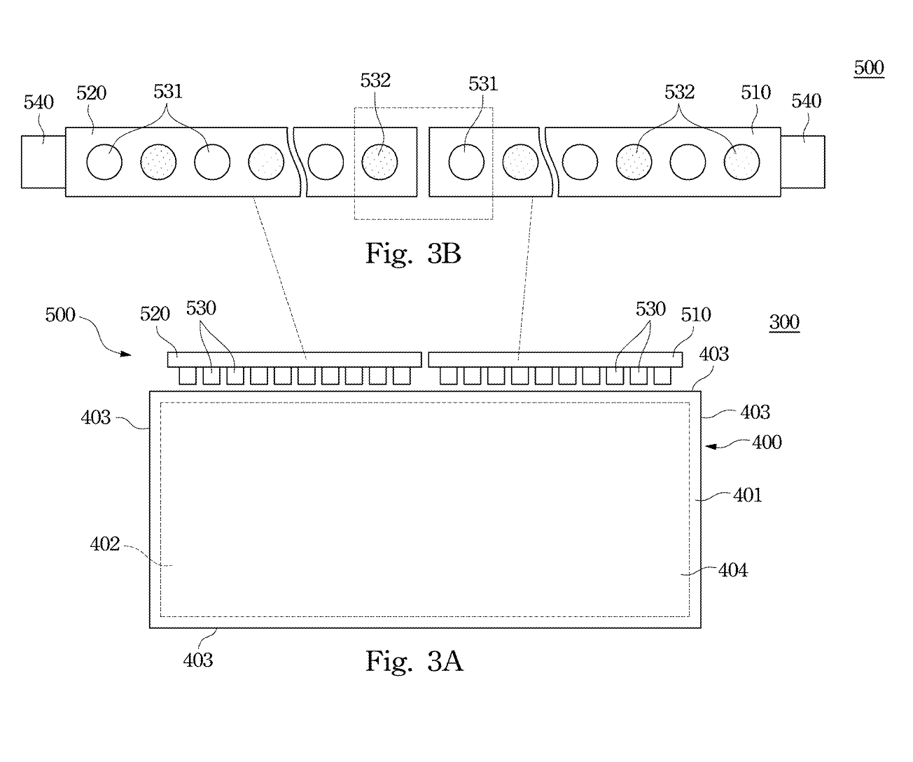

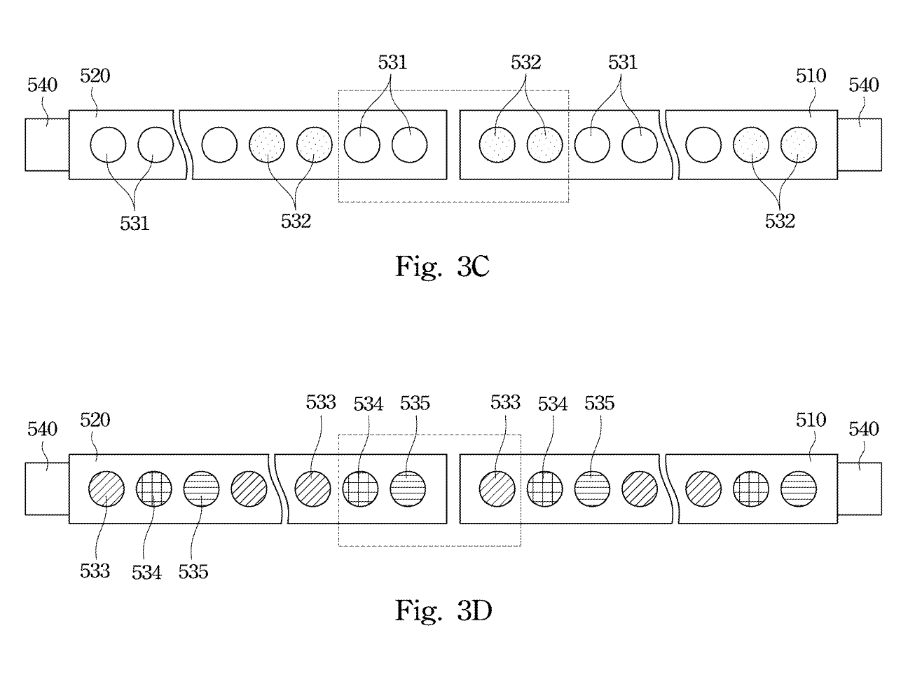

Referring to FIG. 2 and FIG. 3A, wherein FIG. 2 is a schematic view of the display of one embodiment of the present invention; FIG. 3A is a schematic view of the backlight module of one embodiment of the present invention.

The present invention provides an optoelectronic device, a display 100 and a backlight module 300. The display 100 includes a backlight module 300 and a display panel 200.

The backlight module 300 at least includes a light transmission member 400 and a light emitting module 500. The light transmission member 400, for example is in a plate-like shape, and formed with a front surface 401 and a rear surface 402 opposite to the front surface 401, and a plurality of lateral surfaces 403 surrounding the front surface 401 and the rear surface 402; the area of the front surface 401 and the area of the rear surface 402 are both larger than the area of one of the lateral surfaces 403, and the front surface 401 of the light transmission member 400 has an effective light output area (or namely light emitting area) 404. Moreover, the rear surface 402 or any of the lateral surfaces 403 of the light transmission member 400 can be served as a light incident surface for introducing lights into the light transmission member 400, and the effective light-outputting area 404 is served to output lights to the display panel 200. Preferably, light transmission member 400 within a light uniformed function, for example, a light guide plate (film), a diffusion plate (film), or other suitable optical plates (films).

Referring to FIG. 3A and FIG. 3B, wherein FIG. 3B is a schematic view illustrating the arrangement of light emitting units 530 of one embodiment shown in FIG. 3A.

The light emitting module 500 at least includes a first circuit substrate 510, a second circuit substrate 520 and a plurality of light emitting units 530 (e.g. white-light LEDs). The first circuit substrate 510 and the second circuit substrate 520 are both in elongated shapes and have a long side and a short side. The first circuit substrate 510 and the second circuit substrate 520 are respectively disposed at one side of the light incident surface of the light transmission member 400, and a short side of the first circuit substrate 510 is corresponding to a short side of the second circuit substrate 520. The opposite short sides of the first circuit substrate 510 and the second circuit substrate 520 has a connecting portion 540 for connecting to the display 100 so as to provide power and signals to the light emitting units 530. The light emitting units 530 are linearly arranged on the first circuit substrate 510 and the second substrate 520 with equal intervals, and all face the light incident surface and emit lights towards the light incident surface.

The light emitting units 530 are all distributed within the plural chromaticity coordinates mentioned above, and mixedly disposed on the first circuit substrate 510 and the second circuit substrate 520, so that the mixed illumination chromaticity of all the light emitting units 530 disposed on the first circuit substrate 510 is the white light of the average chromaticity range; the mixed illumination chromaticity of all the light emitting units 530 disposed on the second circuit substrate 520 is the white light of the average chromaticity range, and the illumination chromaticity of plural light emitting units 530 which are adjacent to each other and disposed on the first circuit substrate 510 and the second circuit substrate 520 is also the white light of the average chromaticity range.

Accordingly, the illumination chromaticity of the plural light emitting units 530 which are adjacent to each other and disposed on the first circuit substrate 510 and the second circuit substrate 520 is substantially the same as the mixed illumination chromaticity of other light emitting units 530 which are respectively disposed on the first circuit substrate 510 and the second circuit substrate 520.

So the light emitting module 500 provides unified white light to the light transmission member 400 for avoiding poor mixing of lights and for increasing the light-outputting quality of the backlight module 300. In this embodiment, a display panel 200 under 55 inches can be adopted as an example. When light is inputted from a lateral surface of the light transmission member 400, the light emitting module 500 is disposed at the long side of the light transmission member 400. When the display panel is larger than 55 inches in size, the light emitting module 500 can be optionally disposed at the short side of the light transmission member 400.

Several embodiments thereunder illustrate arrangements of the light emitting units 530 for further disclosures and do not serve as a limitation for arrangements of said light emitting units 530, which can be selectively arranged according to actual needs.

Referring to FIG. 1 and FIG. 3B. In the first embodiment of the present invention, the light emitting units 530 can be grouped into a plurality of first light emitting diodes 531 and a plurality of second light emitting diodes 532. Each first light emitting diode 531 has a first illumination chromaticity (e.g. cold color chromaticity, preferably to be cold color closing to white chromaticity), each second light emitting diode 532 has a second illumination chromaticity (e.g. warm color chromaticity, preferably to be warm color closing to white chromaticity). The first illumination chromaticity and the second illumination chromaticity are illumination chromaticity of chromaticity coordinates (e.g. the A chromaticity coordinate and the I chromaticity coordinate) symmetrically defined from two side of the middle chromaticity coordinate (e.g. the E chromaticity coordinate).

Wherein a part of the first light emitting diodes 531 and the second light emitting diodes 532 are disposed on the first circuit substrate 510 with an arrangement of staggering one first light emitting diode 531 with one second light emitting diode 532; the rest of the first light emitting diodes 531 and second light emitting diodes 532 are disposed on the second circuit substrate 520 with the arrangement of staggering one first light emitting diode 531 with one second light emitting diode 532; and as shown in dotted lines in FIG. 3B, a light emitting unit disposed on the first circuit substrate 510 and closest to the second circuit substrate 520 is defined as the first light emitting diode 531, and a light emitting unit disposed on the second circuit substrate 520 and closest to the first circuit substrate 510 is defined as the second light emitting diode 532.

The chromaticity coordinate of the first illumination chromaticity is substantially not the same as the chromaticity coordinate of the second illumination chromaticity, and the mentioned middle chromaticity coordinate (e.g. the E chromaticity coordinate) is between the chromaticity coordinate of the first illumination chromaticity and the chromaticity coordinate of the second illumination chromaticity, and the white light of the middle chromaticity coordinate is obtained after mixing the first illumination chromaticity and the second illumination chromaticity.

For example, when the first illumination chromaticity is at the outmost chromaticity coordinate shown in FIG. 1 along the Q1 direction (e.g. the A chromaticity coordinate) and presents blue (cold) light, the second illumination chromaticity is at the outmost chromaticity coordinate shown in FIG. 1 along the Q2 direction (e.g. the I chromaticity coordinate) and presents red (warm) light. Thus, as shown in dotted lines in FIG. 3B, the first light emitting diode 531 which is disposed on the first circuit substrate 510 and closest to the second circuit substrate 520 can cooperate with the adjacent second light emitting diode 532 disposed on the first circuit substrate 510 to mixedly emit white light, and the first light emitting diode 531 also can cooperate with the adjacent second light emitting diode 532 disposed on the second circuit substrate 520 to mixedly emit white light.

Another example, when the first illumination chromaticity is within the chromaticity coordinates along the Q1 direction as shown in FIG. 1 (e.g. the D chromaticity coordinate) and emits bluish-white (cold) light, and the second illumination chromaticity is within the chromaticity coordinates along the Q2 direction as shown in FIG. 1 (e.g. the F chromaticity coordinate) and emits reddish-white (warm) light. Thus, as shown in dotted lines in FIG. 3B, the first light emitting diode 531 disposed on the first circuit substrate 510 and closest to the second circuit substrate 520 can cooperate with the adjacent second light emitting diode 532 disposed on the first circuit substrate 510 to mixedly emit white light, and the first light emitting diode 531 can cooperate with the adjacent second light emitting diode 532 disposed on the second circuit substrate 520 to mixedly emit white light.

Referring to FIG. 1 and FIG. 3C, wherein FIG. 3C is a schematic view of another embodiment illustrating the arrangement of the light emitting units shown in FIG. 3A. The first light emitting diodes 531 and the second light emitting diodes 532 can be arranged, with an arrangement of staggering two first light emitting diodes 531 with two second light emitting diode 532, on the first circuit substrate 510 and the second circuit substrate 520. As shown in the dotted lines in FIG. 3C, two light emitting units disposed on the first circuit substrate 510 and closest to the second circuit substrate 520 are defined as the second light emitting diodes 532, and two light emitting units disposed on the second circuit substrate 520 and closest to the first circuit substrate 510 are defined as the first light emitting diodes 531. The two second light emitting diodes 532 disposed on the first circuit substrate 510 and closest to the second circuit substrate 520 can cooperate with two adjacent first light emitting diodes 531 disposed on the first circuit substrate 510 to mixedly emit white light, and the two second light emitting diodes 532 also can cooperate with two adjacent first light emitting diodes 531 disposed on the second circuit substrate 520 to mixedly emit white light.

Referring to FIG. 1 and FIG. 3D, wherein FIG. 3D is a schematic view of another embodiment illustrating another arrangement of the light emitting units shown in FIG. 3A. In the second embodiment of the present invention, the light emitting units can be grouped into a plurality of third light emitting diodes 533, a plurality of fourth light emitting diodes 534 and a plurality of fifth light emitting diodes 535. Each third light emitting diode 533 has a third illumination chromaticity. Each fourth light emitting diode 534 has a fourth illumination chromaticity. Each fifth light emitting diode 535 has a fifth illumination chromaticity.

The third light emitting diodes 533, the fourth light emitting diodes 534 and the fifth light emitting diodes 535 are in sequence arranged on the first circuit substrate 510 and the second circuit substrate 520, and the sequence arrangements of the third light emitting diodes 533, the fourth light emitting diodes 534 and the fifth light emitting diodes 535 can be arranged with the adjacent first circuit substrate 510 and the second circuit substrate 520, in other words, as shown in the dotted lines in FIG. 3D, three light emitting units disposed on the first circuit substrate 510 and the second circuit substrate 520 and adjacent to each other are defined as the third light emitting diode 533, the fourth light emitting diode 534 and the fifth light emitting diode 535.

For instance, the light emitting unit disposed on the first circuit substrate 510 and closest to the second circuit substrate 520 is defined as the third light emitting diode 533, and the two light emitting units disposed on the second circuit substrate 520 and closest to the first circuit substrate 510 are in sequence defined as the fourth light emitting diode 534 and the fifth light emitting diode 535. Or for example, the light emitting unit disposed on the first circuit substrate 510 and closest to the second circuit substrate 520 is defined as the fourth light emitting diode 534, the two light emitting units disposed on the second circuit substrate 520 and closest to the first circuit substrate 510 are in sequence defined as the fifth light emitting diode 535 and the third light emitting diode 533.

The mentioned third illumination chromaticity can be, e.g. cold chromaticity, the mentioned fourth illumination chromaticity can be, e.g. warm chromaticity and the mentioned fifth illumination chromaticity can be white chromaticity or either cold chromaticity or warm chromaticity, such that after mixing the third illumination chromaticity, the fourth illumination chromaticity and the fifth illumination chromaticity, the white light in the middle chromaticity coordinate is obtained.

Thus, the light emitting unit, e.g. the third light emitting diode 533, disposed on the first circuit substrate 510 and closest to the second circuit substrate 520 can cooperate with the two adjacent light emitting units, e.g. the fourth light emitting diode 534 and the fifth light emitting diode 535, disposed on the first circuit substrate 510 to mixedly emit white light, or the light emitting unit, e.g. the third light emitting diode 533, also can cooperate with the two adjacent light emitting units, e.g. the fourth light emitting diode 534 and the fifth light emitting diode 535, disposed on the second circuit substrate 520 to mixedly emit white light.

For example, when the third illumination chromaticity is at the outmost chromaticity coordinate shown in FIG. 1 along the Q1 direction (e.g. the A chromaticity coordinate) and presents blue (cold) light, the fourth illumination chromaticity is at the outmost chromaticity coordinate shown in FIG. 1 along the Q2 direction (e.g. the I chromaticity coordinate) and presents red (warm) light, the fifth illumination chromaticity can be at the middle chromaticity coordinate as shown in FIG. 1 (e.g. the E chromaticity coordinate) and presents white color, such that the third light emitting diodes 533, the fourth light emitting diodes 534 and the fifth light emitting diodes 535 can be mixed so as to emit white light.

For instance again, when the third illumination chromaticity is at the outmost chromaticity coordinate shown in FIG. 1 along the Q1 direction (e.g. the A chromaticity coordinate) and presents blue (cold) light, the fourth illumination chromaticity is at the chromaticity coordinate shown in FIG. 1 along the Q2 direction (e.g. the F chromaticity coordinate) and presents reddish-white (warm) light, the fifth illumination chromaticity is at the chromaticity coordinate shown in FIG. 1 along the Q2 direction (e.g. the H chromaticity coordinate) and presents light red (warm) light, such that the third light emitting diodes 533, the fourth light emitting diodes 534 and the fifth light emitting diodes 535 can be mixed so as to emit white light.

Referring to FIG. 1 and FIG. 3E, wherein FIG. 3E is a schematic view of another embodiment illustrating another arrangement of the light emitting units shown in FIG. 3A. In the third embodiment of the present invention, the light emitting units are grouped into a plurality of first light emitting diodes 531 and a plurality of second light emitting diodes 532 and at least two sixth light emitting diodes 536. Each first light emitting diode 531 has a first illumination chromaticity, e.g. cold chromaticity. Each second light emitting diode 532 has a second illumination chromaticity, e.g. warm chromaticity. All the sixth light emitting diodes 536 have white chromaticity.

A part of the first light emitting diodes 531 and the second light emitting diodes 532 are disposed on the first circuit substrate 510 with an arrangement of staggering one first light emitting diode 531 with one second light emitting diode 532, and the rest of the first light emitting diodes 531 and second light emitting diodes 532 are disposed on the second circuit substrate 520 with the arrangement of staggering one first light emitting diode 531 with one second light emitting diode 532. As shown in dotted lines in FIG. 3E, two light emitting units disposed on the first circuit substrate 510 and the second circuit substrate 520 and adjacent to each other are defined as the sixth light emitting diodes 536.

For example, when the first illumination chromaticity is at the outmost chromaticity coordinate shown in FIG. 1 along the Q1 direction (e.g. the A chromaticity coordinate) and presents blue (cold) light, the second illumination chromaticity is at the outmost chromaticity coordinate shown in FIG. 1 along the Q2 direction (e.g. the I chromaticity coordinate) and presents red (warm) light; because the sixth light emitting diodes 536 have white chromaticity, the first light emitting diodes 531, the second light emitting diodes 532 and the sixth light emitting diodes 536 disposed on the first circuit substrate 510 are all mixed to emit white light; and the first light emitting diodes 531, the second light emitting diodes 532 and the sixth light emitting diodes 536 disposed on the second circuit substrate 520 are all mixed to emit white light.

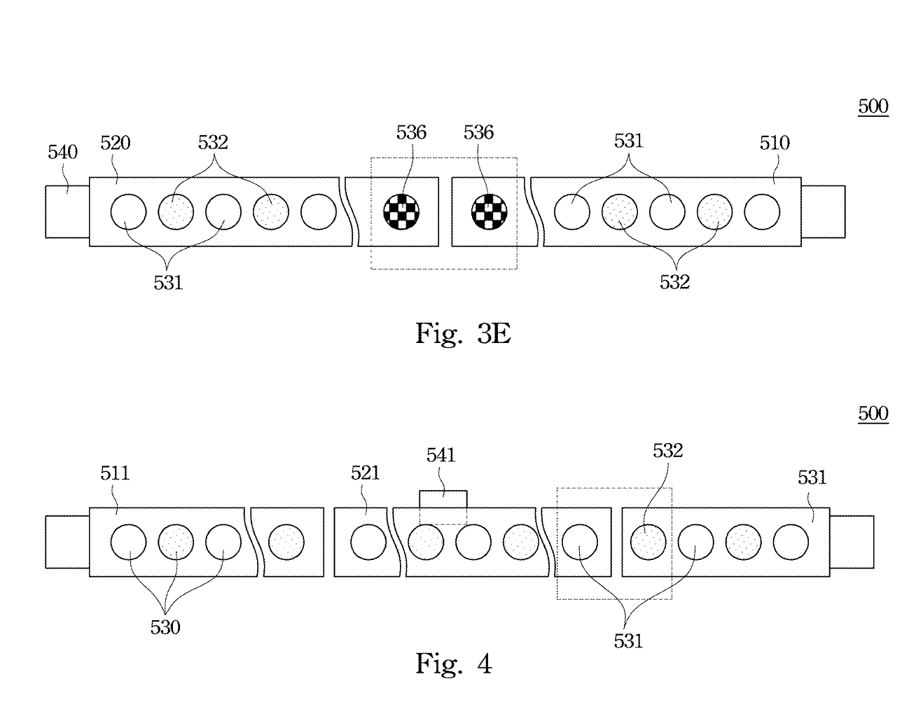

Moreover, refer to FIG. 1 and FIG. 4, wherein FIG. 4 is a schematic view of the backlight module 300 of another embodiment of the present invention. The light emitting module 500 is further disposed with three circuit substrates, i.e. a first circuit substrate 511, a second circuit substrate 521 and a third circuit substrate 531, all in elongated shape and have long sides and short sides. The first circuit substrate 511, the second circuit substrate 521 and the third circuit substrate 531 are respectively disposed at one lateral side of the light incident surface of the light transmission member 400 (as shown in FIG. 3A), and one short side of the first circuit substrate 511 is corresponding to one short side of the second circuit substrate 521; the other short side of the second circuit substrate 521 is corresponding to one short side of the third circuit substrate 531; and a long side of the second circuit substrate 521 has a connecting portion 541. The light emitting units 530 are linearly arranged on the first circuit substrate 511, the second circuit substrate 521 and the third circuit substrate 531, and all face the mentioned light incident surface and emit lights towards the light incident surface.

Similarly, the light emitting diodes 530 can also be mixedly arranged on the first circuit substrate 511, the second circuit substrate 521 and the third circuit substrate 531 with the arrangements disclosed in the described embodiments, so the illumination chromaticity of two light emitting units 530 disposed on the second circuit substrate 521 and the third circuit substrate 531 and adjacent to each other are substantially the same as the illumination chromaticity of mixing the other light emitting units 530 disposed on the third circuit substrate 531.

As mentioned above, the circuit substrates 511, 521, 531 can be practiced as a printed circuit board (PCB), a metal core printed circuit board (MCPCB) or a flexible printed circuit board (FPC). The light emitting units 530 can be practiced as side view LEDs or top view LEDs. Furthermore, the illuminating material adopted in the light emitting units 530 can be practiced as organic material, inorganic material or a combination thereof.

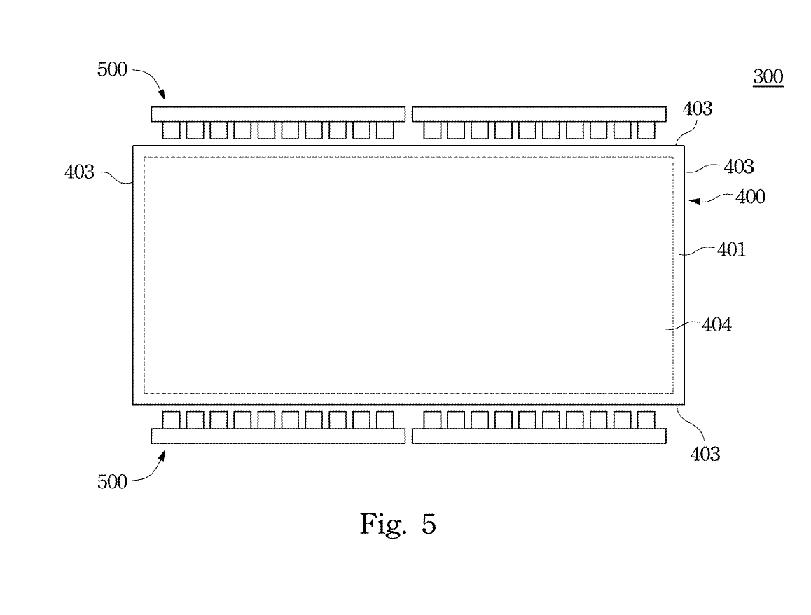

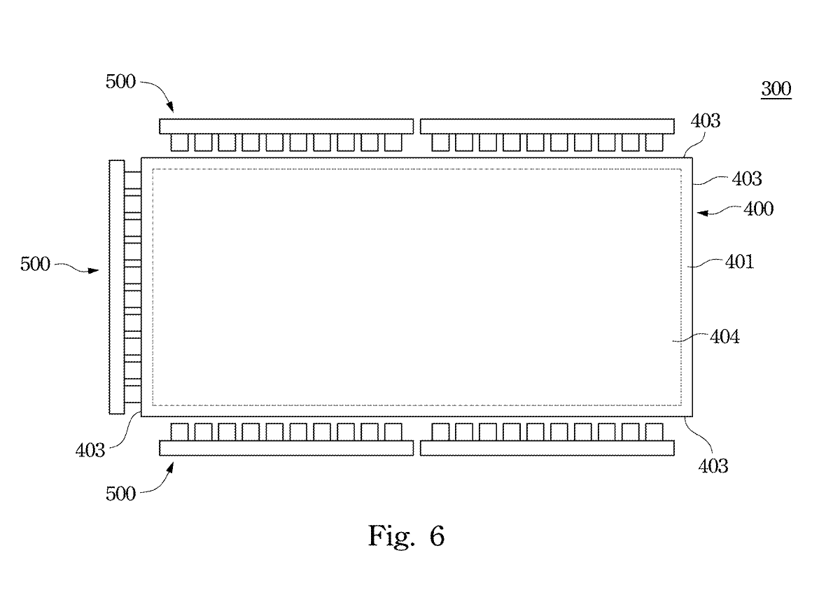

Moreover, the light transmission member 400 can be practiced as a light guide panel or a diffusion panel. Referring to FIG. 3A, FIG. 5 and FIG. 6; wherein FIG. 5 and FIG. 6 are schematic views of the backlight module 300 of one another embodiment of the present invention. When the light transmission member 400 is a light guide panel, any lateral surface 403 of the light transmission member 400 can be served as the light incident surface, such that, according to actual needs, one lateral surface 403 (FIG. 3A), two opposite lateral surfaces 403 (FIG. 5), three adjacent lateral surfaces 403 (FIG. 6) or four adjacent lateral surfaces 403 can be disposed on the light emitting module 500, and the light emitting units 530 can be arranged on the circuit substrates with respect to the arrangement disclosed in the mentioned embodiments.

What shall be noted is that the light emitting units 530 disposed on the short side of the light transmission member 400, as shown in FIG. 6, is one single circuit substrate, as an example only, not a limitation. When the display panel is large in size, e.g. larger than 55 inches, the size of the light transmission member 400 is simultaneously enlarged, and the light emitting units 530 disposed at the short side of the light transmission member 400 can adopt at least two circuit substrates and arrange the light emitting diodes thereon with respect to the mentioned embodiments.

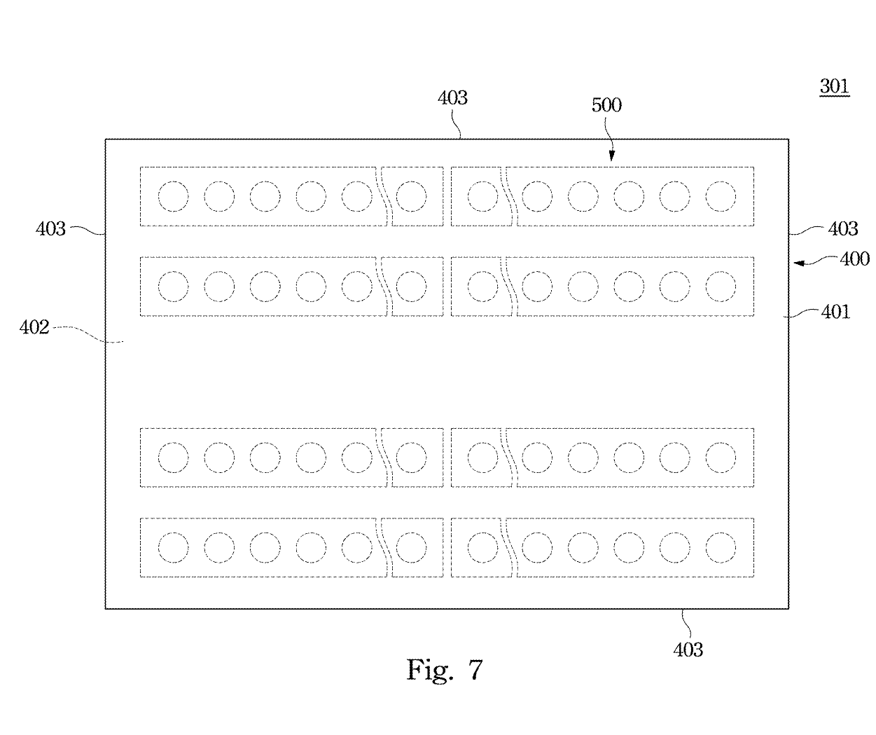

As shown in FIG. 7, where in FIG. 7 is a schematic view of the backlight module 301 of another embodiment of the present invention. When the light transmission member 400 is a diffusion panel, the rear surface 402 of the light transmission member 400 can be served as the light incident surface, such that the light emitting module 500 can be disposed on the rear surface 402 of the light transmission member 400 and faces the rear surface 402 of the light transmission member 400, and the light emitting units 530 can be arranged on the circuit substrates with respect to the arrangement disclosed in the mentioned embodiments.

What shall be noted is that the long side of the circuit substrate of the light emitting module 500 is parallel to the long side of the light transmission member 400 (as viewed from top), the arrangement illustrated in the Figures is served as an example only, not a limitation. In other embodiments, the long side of the circuit substrate of the light emitting module 500 can also be parallel to the short side of the light transmission member 400 as well.

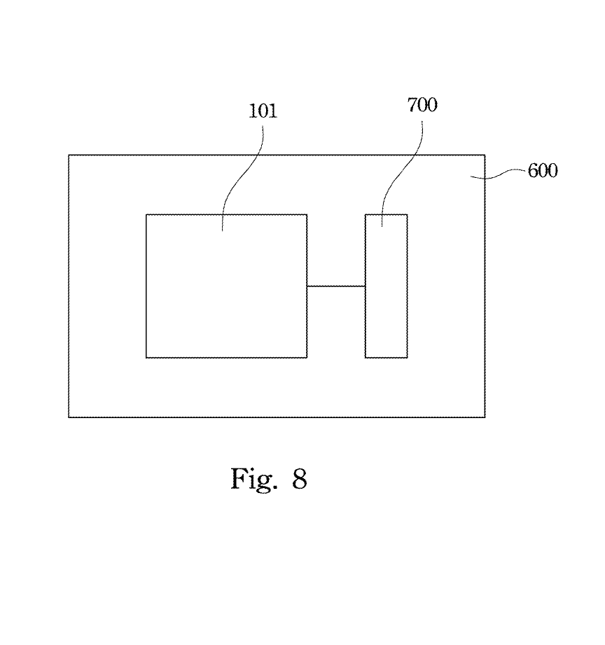

Referring to FIG. 8, wherein FIG. 8 is a schematic view of the optoelectronic device 600 of another embodiment of the present invention. In this embodiment, the optoelectronic device 600 includes a display 101 as shown in FIG. 8 and an electronic unit 700 electrically connected to the display 101. The display 101 is equipped with the mentioned backlight module 300,301 and the light emitting units are arranged on the circuit substrates with respect to the arrangement disclosed in the mentioned embodiments.

The electronic unit 700 can be, in this embodiment, a control unit, an operation unit, a process unit, an input unit, a memory unit, a driver unit, a light emitting unit 530, a protection unit, a sense unit, a detection unit, or units having other functions, or a combination thereof. The optoelectronic device 600 can be a portable product (e.g. a mobile phone, a camera, a notebook, a game device, a watch, a music player, an e-mail receiving/sending device, a GPS device, a digital photo frame or similar products), a video/audio device (e.g. a video/audio player or a similar product), a screen, a television, a bulletin board, or a panel disposed in projector.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
an light transmission member, at least one side of the light transmission member having a light incident surface; and
a light emitting module, disposed in the light incident surface of the light transmission member, and at least comprising:
a first circuit substrate and a second circuit substrate respectively having a short side, and the short side of the first circuit substrate being corresponding to the short side of the second circuit substrate; and
a plurality of light emitting units disposed on the first circuit substrate and the second circuit substrate,
wherein (1) the illumination chromaticity of the light emitting units which are adjacent to each other and disposed on the first circuit substrate and the second circuit substrate, (2) the mixed illumination chromaticity of other light emitting units which are disposed on the first circuit substrate, and (3) the mixed illumination chromaticity of other light emitting units which are disposed on the second circuit substrate are substantially the same.

2. The backlight module of claim 1, wherein the light emitting units comprise:
a plurality of first light emitting diodes having a first illumination chromaticity; and
a plurality of second light emitting diodes having a second illumination chromaticity,
wherein the first light emitting diodes and the second light emitting diodes are disposed on the first circuit substrate and the second circuit substrate with a staggered arrangement,
the first illumination chromaticity is substantially different from the second illumination chromaticity, and
after mixing the first illumination chromaticity and the second illumination chromaticity, white light is provided to emit.

3. The backlight module of claim 2, wherein two of the light emitting units which are adjacent to each other and disposed on the first circuit substrate and the second circuit substrate respectively comprises the first light emitting diode and the second light emitting diode.

4. The backlight module of claim 3, wherein the first light emitting diodes and the second light emitting diodes are disposed on the first circuit substrate and the second circuit substrate with an arrangement of staggering one first light emitting diode with one second light emitting.

5. The backlight module of claim 3, wherein the first light emitting diodes and the second light emitting diodes are disposed on the first circuit substrate and the second circuit substrate with an arrangement of staggering two first light emitting diodes with two second light emitting diodes.

6. The backlight module of claim 3, wherein the first illumination chromaticity is a cold-color chromaticity, the second illumination chromaticity is a warm-color chromaticity.

7. The backlight module of claim 1, wherein the light emitting units comprise:
a plurality of third light emitting diodes having a third illumination chromaticity;
a plurality of fourth light emitting diodes having a fourth illumination chromaticity; and
a plurality of fifth light emitting diodes having a fifth illumination chromaticity, wherein the third light emitting diodes, the fourth light emitting diodes and the fifth light emitting diodes are in sequence arranged on the first circuit substrate and the second circuit substrate, and
after mixing the third illumination chromaticity, the fourth illumination chromaticity and the fifth illumination chromaticity, white light is provided to emit.

8. The backlight module of claim 7, wherein three of the light emitting units which are adjacent together and disposed on the first circuit substrate and the second circuit substrate respectively comprise the third light emitting diode, the fourth light emitting diode and the fifth light emitting diode.

9. The backlight module of claim 7, wherein the third illumination chromaticity, the fourth illumination chromaticity and the fifth illumination chromaticity respectively are a cold-color chromaticity, a warm-color chromaticity and a white chromaticity.

10. The backlight module of claim 7, wherein the third illumination chromaticity and the fourth illumination chromaticity respectively are a cold-color chromaticity and a warm-color chromaticity, and the fifth illumination chromaticity is one of a cold-color chromaticity and a warm-color chromaticity.

11. The backlight module of claim 1, wherein the light emitting units comprise:
at least two sixth light emitting diodes respectively which are adjacent to each other and disposed on the first circuit substrate and the second circuit substrate, wherein the illumination chromaticity of the sixth light emitting diodes is a white chromaticity.

12. The backlight module of claim 1, wherein the backlight module further comprises:
a third circuit substrate having a short side, the short side of the third circuit substrate is corresponding to the other short side of the second circuit substrate,
wherein the light emitting units are disposed on the first circuit substrate, the second circuit substrate and the third circuit substrate,
wherein the illumination chromaticity of two light emitting units which are adjacent to each other and disposed on the second circuit substrate and the third circuit substrate, and the mixed illumination chromaticity of other light emitting units which are disposed on the third circuit substrate are substantially the same.

13. The backlight module of claim 12, wherein the circuit substrates respectively are a printed circuit board (PCB), a metal core printed circuit board (MCPCB) or a flexible printed circuit board (FPC).

14. A display comprising the backlight module of claim 1.

15. An optoelectronic device comprising the display of claim 14.
